(19) United States
(12) Patent Application Publication
(10) Pub. No.: US 2026/0080043 A1
(43) Pub. Date: Mar. 19, 2026

(54) BIOMETRIC TOKEN FOR IDENTITY VERIFICATION

(71) Applicant: Onfido Ltd, London (GB)

(72) Inventors: Daniel Serrano, Lisbon (PT); Giulia Di Nola, London (GB); Miguel Vitorino, Lisbon (PT); Warren Seine, Saint Nom La Bretèche (FR)

(21) Appl. No.: 19/332,419

(22) Filed: Sep. 18, 2025

Related U.S. Application Data
(60) Provisional application No. 63/696,519, filed on Sep. 19, 2024.

(51) Int. Cl. G06F 21/32; G06V 40/16; G06V 40/40; G06V 40/50

(52) U.S. Cl. CPC G06F 21/32; G06V 40/172; G06V 40/45; G06V 40/50

(57) ABSTRACT

A biometric token for identity verification is provided. In examples, during an onboarding process, an authentication server generates the biometric token. In embodiments, the biometric token includes reference biometric data, such as an embedding of an image of a user. During an authentication process, the reference biometric data stored on the biometric token is compared against biometric data captured during the authentication process. In embodiments, the authentication server may not store the reference biometric data for an extended period of time after the onboarding process. In such embodiments, the authentication server may transmit the biometric token to a computing device, such as a user's mobile device, where the biometric token is stored. The biometric token is transmitted from the computing device back to the authentication server for authentication of the user.

### CROSS-REFERENCE TO RELATED APPLICATIONS

This application claims priority to U.S. Provisional Patent Application No. 63/696,519 filed Sep. 19, 2024, the disclosure of which is incorporated herein by reference in its entirety.

### BACKGROUND

Identity and access management platforms enable organizations to authenticate individuals using a variety of authentication methods. For example, biometrics-based solutions may be used to authenticate users attempting to access a secure application. However, authentication is repeated each time a user attempts to access a secure application, requiring continued maintenance of enrollment biometric reference data for matching during the authentication process. Maintaining the biometric reference data at the authentication service may increase the risk of users'information being accessed in a data breach and may violate users'data deletion requirements regarding personally identifiable information.

### SUMMARY

In accordance with aspects of the present disclosure, a biometric token for identity verification is provided. In example aspects, the biometric token includes reference biometric data, such as an embedding of an image of a user, that is used to authenticate the user during an authentication process.

In a first aspect, a system for authenticating a user is provided. The system includes an authentication server comprising one or more processors and one or more computer-readable storage devices storing data instructions. Execution of the data instructions by the one or more processors causes the authentication server to execute an onboarding process and execute an authentication process. To execute the onboarding process includes to receive at least a first image of a user, receive an image of an identity document, and generate a biometric token. The identity document includes a second image of the user. The biometric token includes an embedding of the first image of the user. To execute the authentication process includes to receive a third image of the user, generate an embedding of the third image of the user, compare the embedding of the third image of the user to the embedding of the first image of the user from the biometric token, and authenticate the user based on the comparison.

In a second aspect, a system for authenticating a user is provided. The system comprises a computing device comprising one or more processors and one or more computer-readable storage devices storing data instructions. Execution of the data instructions by the one or more processors causes the computing device to capture at least a first image of a user, capture an image of an identity document, transmit the first image of the user and the image of the identity document to an authentication server, receive a biometric token from the authentication server, store the biometric token, capture a third image of the user, and transmit the third image of the user and the biometric token to the authentication server. The identity document includes a second image of the user. The authentication server verifies an identity of the user based on the first image and the image of the identity document. The biometric token includes an embedding of the first image of the user. The authentication server authenticates the user based on a comparison between an embedding of the third image of the user and the embedding of the first image of the user from the biometric token.

In a third aspect, a method for authenticating a user is provided. The method includes executing an onboarding process at an authentication server and executing an authentication process at the authentication server. The onboarding process includes receiving at least a first image of a user, receiving an image of an identity document, and generating a biometric token. The identity document includes a second image of the user. The biometric token includes an embedding of the first image of the user. The authentication process includes receiving a third image of the user, generating an embedding of the third image of the user, comparing the embedding of the third image of the user to the embedding of the first image of the user from the biometric token, and authenticating the user based on the comparison.

In a fourth aspect, a method for authenticating a user is provided. A first image of a user is received. An embedding of the first image of the user is generated. The embedding of the first image of the user includes a numerical representation of biometric data extracted from the first image of the user. The embedding of the first image of the user is compared to an embedding of a second image of the user. The embedding of the second image of the user is stored on a biometric token. Based on the comparison, the user is authenticated.

In a fifth aspect, a system for authenticating a user is provided. The system includes one or more processors and one or more computer-readable storage devices storing data instructions. Execution of the data instructions by the one or more processors causes the system to capture a first image of a user, transmit the first image of the user to an authentication server, and transmit a biometric token to the authentication server. The biometric token includes an embedding representing biometric data obtained from a second image of the user. The biometric token is stored in the one or more computer-readable storage devices. The user is authenticated by the authentication server based on a comparison between an embedding representing biometric data obtained from the first image of the user and the embedding from the second image of the user from the biometric token.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates an example embodiment of a biometric token issuance system.

FIG. 2 illustrates another example embodiment of a biometric token issuance system.

FIG. 3 illustrates a flowchart of an example method for issuing biometric tokens.

FIG. 4 illustrates a flowchart of another example method for issuing biometric tokens.

FIG. 5 illustrates an example message flow diagram for issuing biometric tokens.

FIG. 6 illustrates an example embodiment of a biometric token authentication system.

FIG. 7 illustrates a flowchart of an example method for authenticating a user using a biometric token.

FIG. 8 illustrates an example message flow diagram for authenticating a user using a biometric token.

FIG. 9 illustrates an example embodiment of a biometric token.

FIG. 10 illustrates example embodiments of token records.

FIG. 11 illustrates an example embodiment of a computing device on which aspects of the present disclosure may be implemented.

### DETAILED DESCRIPTION

In accordance with aspects of the present disclosure, a biometric token for identity verification is provided. In example aspects, the biometric token includes an embedding of reference biometric data that can be used to authenticate a user. For example, during an onboarding process, the reference biometric data that is captured for future authentication processes may be embedded and stored on the biometric token. During an authentication process, the biometric token may be retrieved, and the embedded reference biometric data may be compared against biometric data captured during the authentication process to authenticate a user.

In embodiments, the biometric token is not stored at the authentication service. For example, the biometric token may be stored on a computing device of the user, such as a mobile device. Because the biometric token—which includes an embedding of biometric reference data—is not maintained at the authentication service, the authentication service can authenticate the user without storing personally identifiable information about the user (e.g., the biometric reference data or the embedding thereof) for extended periods of time. Accordingly, the risk of the user's personally identifiable information being exposed in a data breach of the authentication service is reduced, and the authentication service can comply with data deletion requirements regarding personally identifiable information. Furthermore, the biometric token may be encrypted, either at the authentication service or at the computing device of the user, for storage, ensuring security of the embedded biometric reference data.

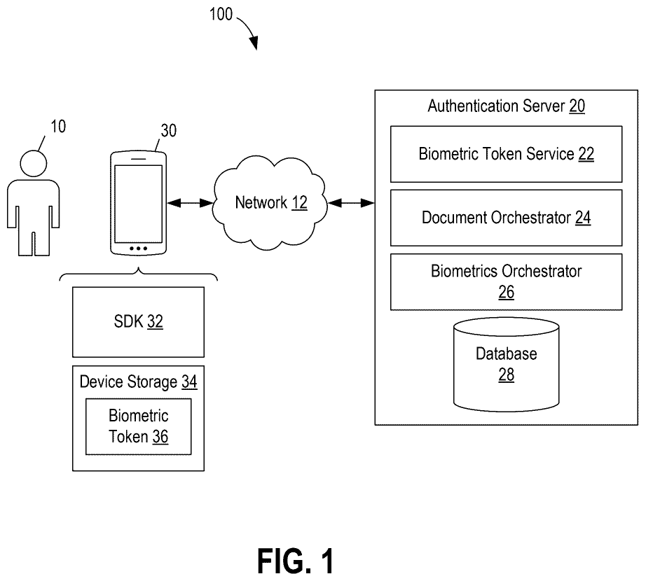

Turning now to FIG. 1, an example biometric token issuance system 100 is shown. In the illustrated embodiment, a biometric token 36 may be issued for a user 10 by an authentication server 20. In an example, the biometric token 36 may be stored in a device storage 34 of a computing device 30 of the user 10. As described further herein, in alternative examples, the biometric token 36 may be stored on other electronic devices. In embodiments, the authentication server 20 communicates with the computing device 30 over a network 12, such as the Internet.

In an embodiment, the biometric token 36 is issued to the user 10 during an onboarding process. During the onboarding process, the authentication server 20 may verify the identity of the user 10 and issue the biometric token 36. In examples, a software development kit (SDK) 32 on the computing device 30 interacts with the authentication server 20 during the onboarding process.

In an example, the computing device 30 captures an image of the user 10, such as an image of the user's face. The image of the user 10 may be transmitted to the authentication server 20 and used to generate the biometric token 36. In an embodiment, a biometric token service 22 on the authentication server 20 generates the biometric token 36.

In embodiments, the biometric token 36 may include information based on the image of the user 10 captured by the computing device 30. In an example, the biometric token 36 is formatted as a JSON payload, which may be serialized to a string and encrypted using the JSON Web Encryption standard as described further herein. In embodiments, the biometric token service 22 generates an embedding of the image of the user 10, and the embedding is added to the biometric token 36. In an embodiment, the embedding of the image of the user 10 includes a numerical representation of biometric data of the user 10 extracted from the image. For example, the embedding of the image of the user 10 may include a feature vector that represents biological characteristics of the user 10.

In examples, the biometric token 36 further includes a token identifier and a user identifier. As described further herein, the token identifier may be used by the authentication server 20 to determine that the biometric token 36 is valid during subsequent authentications using the biometric token 36. In an example, the token identifier may include a signature generated by the authentication server 20. The user identifier may be used during subsequent authentications to confirm that the biometric token 36 belongs to the user 10 being authenticated.

After the biometric token 36 is generated at the authentication server 20, the biometric token 36 is encrypted and transmitted back to the computing device 30 through the SDK 32. In an example, the biometric token is encrypted using an AES-256-GCM symmetric cryptography algorithm and encoded in Base64. For example, an AES-256-GCM cipher with key wrapping may be used to encrypt the biometric token 36; A256GCM may be used to encrypt the biometric token 36, and A256GCMKW may be used to encrypt an encryption key. In embodiments, a decryption key to decrypt the biometric token 36 is maintained by the authentication server 20; the authentication server 20 can then use the decryption key to decrypt the biometric token during authentication processes, as described further herein. In examples, the decryption key is not shared with the computing device 30, so the biometric token 36 can only be decrypted by the authentication server 20.

When the biometric token 36 is generated, the biometric token service 22 may create a token record in a database 28 at the authentication server 20. In examples, the token record maps the token identifier to a user identifier (or a hash thereof) and a status of the biometric token 36. For example, when the biometric token 36 is initially generated but the user has not yet been authenticated, the status of the biometric token 36 may be “processing.”

In embodiments, the user 10 is authenticated during the onboarding process using an identity document, such as a passport or a driver's license. For example, the computing device 30 may capture an image of the identity document. Additionally or alternatively, information captured by reading an integrated circuit embedded within the identity document (e.g., reading an embedded electronic microprocessor chip of a biometric passport). The SDK 32 may transmit the image of the identity document, as well as any other captured information, to the authentication server 20 to be authenticated.

In an embodiment, the biometric token service 22 may authenticate the user 10. The biometric token service 22 may authenticate the user 10 with a document orchestrator 24 and a biometrics orchestrator 26. The document orchestrator 24 may verify that the identity document is authentic. The biometrics orchestrator 26 may verify that the user 10 is who they claim to be. For example, the biometrics orchestrator 26 may compare the image of the user 10 captured by the computing device 30 to an image of the user 10 on the identity document. If the images match, the biometrics orchestrator 26 may determine that the user 10 is the person to which the identity document belongs and the user 10 is who they claim to be.

The token record stored in the database 28 may be updated based on the authentication of the user 10. For example, if the user 10 is authenticated, the status of the biometric token 36 in the token record may be updated to be “valid.” Similarly, if the user 10 is not authenticated, the status of the biometric token 36 in the token record may be updated to be “invalid.”

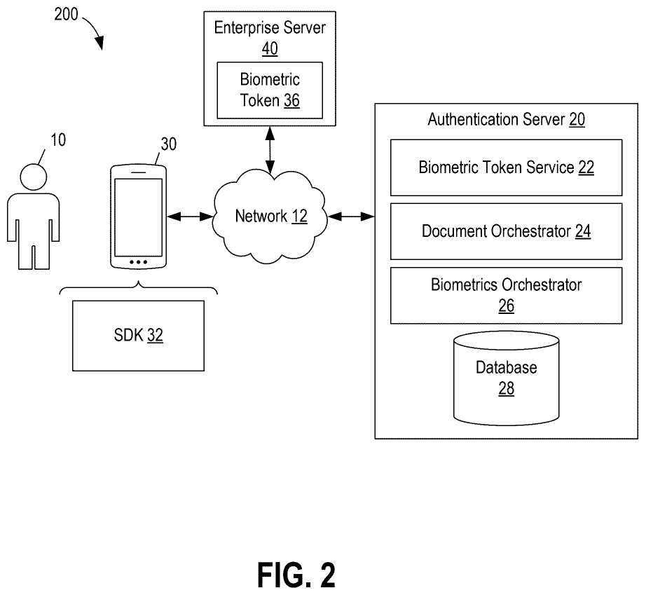

FIG. 2 illustrates an alternative example of a biometric token issuance system 200. The system 200 is substantially similar to the system 100 described above in connection with FIG. 1, but further includes an enterprise server 40. In this embodiment, rather than the biometric token 36 being stored on the computing device 30 of the user 10, the biometric token 36 may be stored on the enterprise server 40. In an example, the biometric token 36 is transmitted directly from the authentication server 20 to the enterprise server 40. In an alternative example, the authentication server 20 transmits the biometric token 36 to the computing device 30, and the computing device 30 transmits the biometric token to the enterprise server 40. Similarly, in further examples, other computing devices may act as an intermediary between the authentication server 20 and the enterprise server 40. The generation of the biometric token 36 may otherwise be the same or substantially similar to the generation of the biometric token 36 as described in connection with FIG. 1 and described further herein. In this instance, the authentication server 20 may be managed by an authentication service, while the enterprise server 40 may be controlled by an enterprise that may similarly manage an application or data of a computing device 30. For example, an enterprise that may control access to enterprise applications using authentication provided by the authentication server 20 may store the biometric token 36 at either the computing device 30 or elsewhere within the enterprise, while still avoiding the requirement that the authentication server 20 store personally identifiable information (PII).

In the systems 100, 200 described above in connection with FIGS. 1 and 2, because reference biometric data (e.g., the embedding of the image of the user 10) is maintained in the biometric token 36 which is stored off of the authentication server 20 (e.g., on the computing device 30 or the enterprise server 40), the authentication server 20 does not need to maintain the reference biometric data—or other personally identifiable information (PII) associated with the user 10—for extended periods of time. As described herein, the biometric token 36 can be returned to the authentication server 20 at the time of authentication. In some embodiments, the personally identifiable information, such as the image of the user 10 and the image of the identity document, or biometric data extracted therefrom, may be temporarily stored in the database 28; however, the personally identifiable information can be deleted at any time after the embeddings are generated; as such, it can be ensured that the personally identifiable information is not retained after the generation of the biometric token 36 and authentication of the user 10. In an example, the personally identifiable information is deleted after the onboarding process has completed, e.g., after successful creation of the biometric token. In another example, the personally identifiable information is stored in the database 28 for less than two days. In some examples, this retention timing is configurable. In alternative examples, the personally identifiable information is never stored in the database 28 and is deleted after the biometric token 36 is generated and the user 10 is authenticated. Accordingly, the authentication server 20 can comply with data retention and deletion policies regarding personally identifiable information.

While the biometric token 36 described in the above examples includes an embedding of an image of the user 10, in alternative embodiments, the biometric token 36 may include embeddings of additional or alternative biometrics of the user 10. Examples of other biometrics include a fingerprint of the user 10, a voice recording of the user 10, and an iris scan of the user 10.

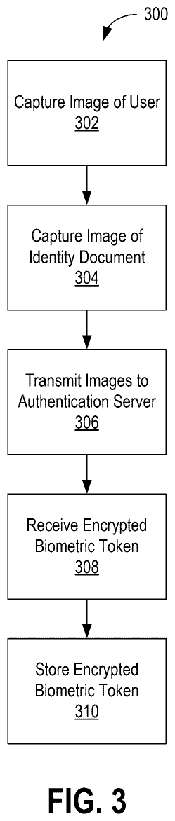

Turning to FIG. 3, a flowchart of an example method 300 for issuing a biometric token is provided. In the illustrated example, the method 300 includes operations 302, 304, 306, 308, 310. In an embodiment, the method 300 may be performed by a computing device, such as the computing device 30 described above in connection with FIGS. 1 and 2.

The operation 302 includes capturing an image of a user. In an example, the image of the user may include an image of the user's face. In some embodiments, multiple images of the user may be captured. For example, multiple images of the user from different perspectives may be captured and used for liveness detection, as described further herein. Similarly, in an embodiment, a video of the user is captured, and a frame from the video may be extracted and used as the image of the user. In alternative embodiments, different biometrics may additionally or alternatively be captured, including a fingerprint of the user, a voice recording of the user, or an iris scan of the user.

In an embodiment, a camera on a computing device captures the image of the user. In embodiments, additional or alternative sensors may be used during the capture of the image. For example, a depth sensor may capture depth information during the capture of the image, which may be used for liveness detection. In further embodiments in which other biometrics are captured, corresponding sensors of the computing device may capture the biometrics—e.g., a fingerprint sensor may capture a fingerprint of the user.

The operation 304 includes capturing an image of an identity document. In an embodiment, the identity document includes biographical information about the user and an image of the user. In examples, the image of the identity document captures the biographical information and the image of the user. In some embodiments, multiple images of the identity document may be captured. For example, images of a front side and a back side of the identity document may be captured.

In alternative embodiments, information may be extracted from the identity document in additional or alternative ways. For example, the identity document may include an integrated circuit embedded within the identity document that may store the information that is presented on the identity document (e.g., the biographical information and image of the user). In this example, the information may be extracted from the identity document by reading the integrated circuit.

In embodiments, a camera on a computing device captures the image of the identity document. In some embodiments, such as those in which information is extracted from an integrated circuit embedded within the identity document, other components of the computing device may be used to capture information from the identity document. For example, a near-field communication (NFC) reader may read data from the integrated circuit of the identity document.

The operation 306 includes transmitting the image of the user and the image of the identity document to an authentication server. In alternative embodiments, additional or alternative information that is captured during the operations 302, 304 are transmitted to the authentication server. For example, other biometric information captured about the user may be transmitted to the authentication server. Similarly, data captured from an integrated circuit embedded in the identity document may be transmitted to the authentication server. In an embodiment, a computing device transmits the images to the authentication server over a network using a wireless interface.

The operation 308 includes receiving an encrypted biometric token from the authentication server. As described herein, in an embodiment, the encrypted biometric token includes an embedding of the image of the user captured during the operation 302. In an embodiment, a computing device receives the encrypted biometric token from the authentication server over a network using a wireless interface.

The operation 310 includes storing the encrypted biometric token. In an example, the encrypted biometric token is stored such that it can be retrieved to authenticate the user during future authentication processes. In an embodiment, the encrypted biometric token is stored in a memory of a computing device. In an alternative embodiment, the encrypted biometric token may be stored on an enterprise server of an enterprise to which the user belongs. In such embodiments, a computing device that receives the encrypted biometric token from the authentication server may transmit the encrypted biometric token to the enterprise server for storage. In an alternative example, the enterprise server receives the encrypted biometric token directly from the authentication server.

While the method 300 describes issuing a biometric token based including an embedding of an image of a user, in alternative embodiments, the biometric token issued during the method 300 may include other reference biometric data.

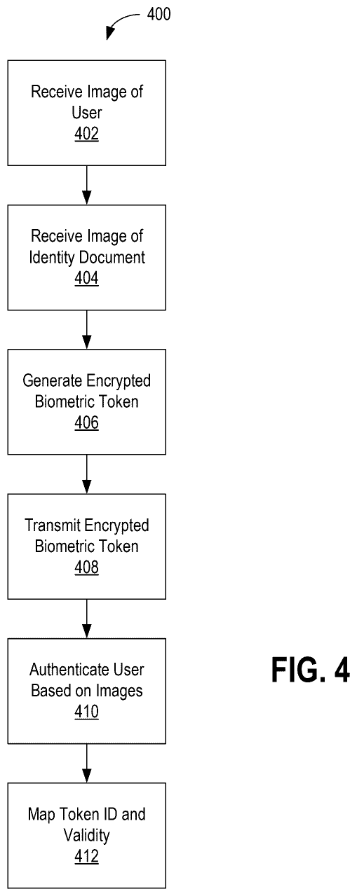

FIG. 4 illustrates a flowchart of another example method 400 for issuing a biometric token. In the illustrated example, the method 400 includes operations 402, 404, 406, 408, 410, 412. In an example embodiment, an authentication server may perform the method 400.

The operation 402 includes receiving image data including an image of a user. In an example, the image of the user includes an image of the user's face. In some embodiments, multiple images of the user are received. For example, images of the user taken from multiple perspectives may be received, and/or may be received in the form of video data. Similarly, additional data may be received along with the image data of the user, such as depth information captured by a depth sensor. In alternative embodiments, other biometric information is received in addition or alternative to the image for the user, such as a fingerprint of the user, a voice recording of the user, or an iris scan of the user.

In an embodiment, an authentication server receives the image data including the image of the user. For example, the authentication server may receive the image of the user from a computing device over a network using a wireless interface.

The operation 404 includes receiving additional image data, including an image of an identity document. In an example, the image of the identity document includes an image of biographical information of the user and an image of the user on the identity document. In some embodiments, additional or alternative information from the identity document may be received. For example, data (e.g., biographical information and an image of the user) extracted from an integrated circuit embedded within the identity document may be received. In an embodiment, the authentication server receives the image of the identity document from a computing device over a network using a wireless interface.

The operation 406 includes generating an encrypted biometric token. In an embodiment, the encrypted biometric token is based on the image of the user received during the operation 402. For example, the encrypted biometric token may include an embedding of the image of the user. As described above, in an embodiment, the embedding of the image of the user includes a numerical representation of biometric data of the user extracted from the image. For example, the embedding of the image of the user 10 may include a feature vector that represents biological characteristics of the user.

In some embodiments, the encrypted biometric token may further include a token identifier and a user identifier, as described further herein. In embodiments, the token identifier may include a signature generated by an authentication server that generates the biometric token. In an example, after the data in the biometric token is compiled (e.g., the embedding and the identifiers), the biometric token is encrypted. In an embodiment the biometric token is encrypted using an AES-256-GCM symmetric cryptography algorithm and encoded in Base64.

In an embodiment, when generating the encrypted biometric token, a biometric token record is created. In an example, the biometric token record maps a token identifier to a user identifier and a status of the biometric token. For example, as the biometric token is being generated, the biometric token may be assigned a “processing” status. In an embodiment, a database of an authentication server maintains the encrypted biometric token record.

The operation 408 includes transmitting the encrypted biometric token to a computing device. In an embodiment, the computing device is a computing device belonging to the user. In another embodiment, the computing device is an enterprise server. In an example, an authentication server transmits the encrypted biometric token to the computing device over a network using a wireless interface.

The operation 410 includes authenticating the user based on the images of the user and the identity document. In an example, the image of the identity document is used to verify that the identity document is authentic. The image of the user may be used to verify that the user is who they claim to be. For example, the image of the user may be compared to an image on the identity document—e.g., by comparing embeddings of the images. If the image of the user matches the image from the identity document, the user may be authenticated.

In an embodiment, a document orchestrator authenticates the identity document, and a biometrics orchestrator authenticates the user. In examples, the document orchestrator and the biometrics orchestrator operate on an authentication server.

The operation 412 includes mapping a token identifier to a validity of the biometric token. In an embodiment, the validity of the biometric token is based on the authentication of the user described above in the operation 410. For example, if the user is successfully authenticated, the biometric token is considered valid by the authentication server, and if the user is not authenticated, the biometric token is considered invalid.

In an embodiment, the biometric token record is updated based on the validity of the biometric token. As described above, the biometric token record maps a token identifier to a status of the biometric token. If the user is authenticated during the operation 410, the status of the biometric token may be updated to be “valid.” Similarly, if the user is not authenticated during the operation 410, the status of the biometric token may be updated to be “invalid.” In an embodiment, a database of an authentication server maintains the biometric token record and is updated based on the validity of the biometric token.

While the method 400 describes issuing a biometric token based including an embedding of an image of a user, in alternative embodiments, the biometric token issued during the method 400 may include other reference biometric data.

In alternative embodiments, the method 400 may be performed in a different order than shown in FIG. 4. For example, in an embodiment, the operation 410 to authenticate the user based on the image of the user and the image of the identity document may be performed before the operation 406 to generate the encrypted biometric token. Similarly, in some embodiments, two or more operations may be performed concurrently.

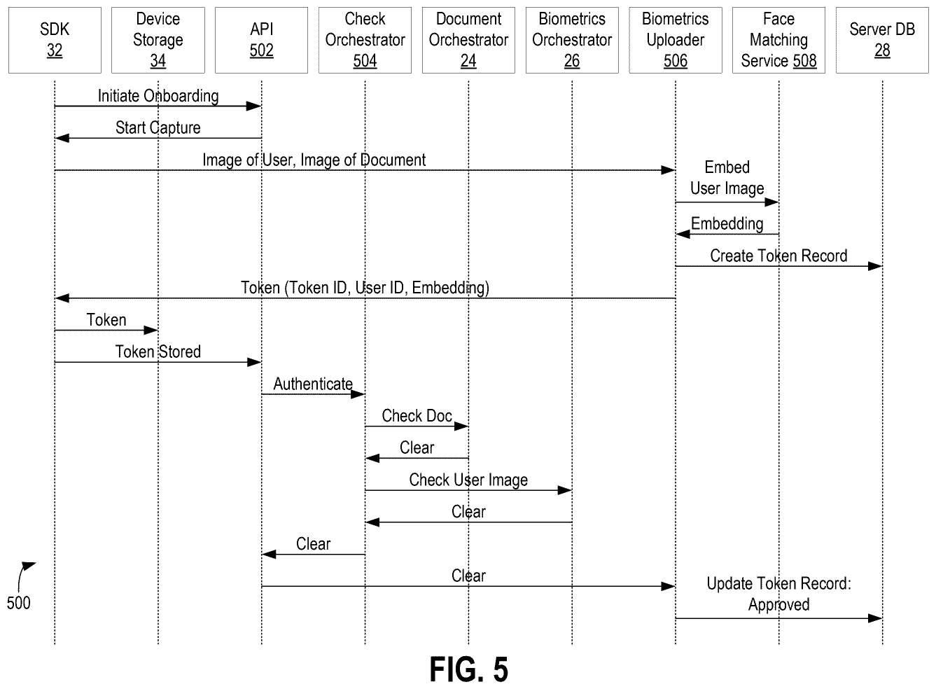

FIG. 5 illustrates an example message flow diagram 500 for issuing a biometric token. The illustrated message flow diagram 500 shows communications between an SDK 32, a device storage 34, an application programming interface (API) 502, a check orchestrator 504, a document orchestrator 24, a biometrics orchestrator 26, a biometrics uploader 506, a face matching service 508, and an authentication server database 28. In an embodiment, the SDK 32 and the device storage 34 are part of a user's computing device. The API 502, the check orchestrator 504, the document orchestrator 24, the biometrics orchestrator 26, the biometrics uploader 506, the face matching service 508, and the authentication server database 28 may be part of an authentication server.

The onboarding process may be initialized by the SDK 32 informing the API 502 that onboarding should begin. In an example, a user may initiate onboarding using the SDK 32 on a computing device of the user. The API 502 may respond by instructing the SDK 32 to begin image capture. As described above, an image of a user and an image of an identity document may be captured during the onboarding process.

The captured images (e.g., the image of the user and the image of the identity document) may be uploaded from the SDK 32 to the biometrics uploader 506. The biometrics uploader 506 may request that the face matching service 508 generate an embedding of the image of the user. In an example, the face matching service 508 may process the image prior to generating the embedding, such as by cropping the image of the user to center the user's face in the image. The embedding of the image of the user is returned from the face matching service 508 to the biometrics uploader 506. In an example, the embedding of the image includes a feature vector representative of biological characteristics of the user.

The biometrics uploader 506 may generate the biometric token. In an example, the biometric token includes the embedding generated by the face matching service 508, a token identifier, and a user identifier. In an example, the token identifier is generated by the biometrics uploader 506 and the user identifier is an identifier of the user that initiated the onboarding process, which may be received from the SDK 32 along with the image of the user and the image of the identity document. In embodiments, the token identifier may include a signature generated by an authentication server.

The biometrics uploader 506 may create a token record in the authentication server database 28. As described herein, the token record may include the token identifier, a user identifier, and a status of the biometric token. In an example, the status of the biometric token may be set as “processing”when the token record is initially created.

The biometrics uploader 506 may encrypt the biometric token and transmit the encrypted biometric token to the SDK 32. The SDK 32 may store the encrypted biometric token in the device storage 34. As described further herein, the encrypted biometric token may be retrieved from the device storage 34 during future authentication processes to authenticate the user. The SDK may inform the API 502 that the biometric token has been stored.

After the API 502 is notified that the biometric token has been stored, in some examples, any biometric data stored at the biometrics uploader 506 or other components of an authentication server may be caused to delete biometric data, while retaining the token record. This enables a subsequently-received version of the biometric token to be associated with a particular token record, ensuring that a biometric authentication process is performed for only users registered with the authentication server.

The API 502 may call the check orchestrator 504 to ensure that the identity document is authentic and the user is who they claim to be. The check orchestrator 504 may use the document orchestrator 24 to authenticate the identity document. The check orchestrator 504 may similarly use the biometrics orchestrator 26 to verify that the user is who they claim to be. For example, the biometrics orchestrator 26 may compare the image of the user captured during the onboarding process to an image of the user on the identity document, such as by generating embeddings of both images (or by using embeddings generated by the face matching service) and comparing the embeddings. As described above, the embeddings may be numerical representations, such as feature vectors, representative of biometric data of the user extracted from the images. If the embeddings match—e.g., a Euclidean distance between the embeddings is less than a predetermined threshold—the biometrics orchestrator may authenticate the user. Additionally, in some embodiments, the biometrics orchestrator 26 may perform liveness detection on the image of the user to verify that the user is a real person and not a spoof.

After the identity document and the user are authenticated, the check orchestrator 504 may inform the API 502 that the authentication has been completed. The API 502 may inform the biometrics uploader 506 of the results of the authentication, and the biometrics uploader 506 may update the token record in the authentication server database 28. For example, if the user and the identity document are authenticated, the status of the biometric token in the token record may be updated to “valid.” Similarly, if the user or the identity document are not authenticated, the status of the biometric token in the token record may be updated to “invalid.” As described further herein, a biometric token may need to be valid in order for the biometric token to be used to authenticate a user during an authentication process.

In some examples, additionally, at a time after the token record is updated to valid, biometric data stored at the authentication server may be deleted, while retaining the token record. In this way, the authentication server may ensure that the biometric token was successfully used for authentication prior to discarding the biometric data included in the biometric token.

While FIG. 5 illustrates an example of a message flow diagram 500 for issuing a biometric token, in alternative examples, the messages may be transmitted in a different order. For example, in an embodiment, the identity document and the user may be authenticated before the biometric token is generated.

Similarly, while the example message flow diagram 500 describes generating a biometric token with an embedding of an image of the user, in alternative embodiments, the biometric token may include an embedding of different biometric data, such as a fingerprint of the user.

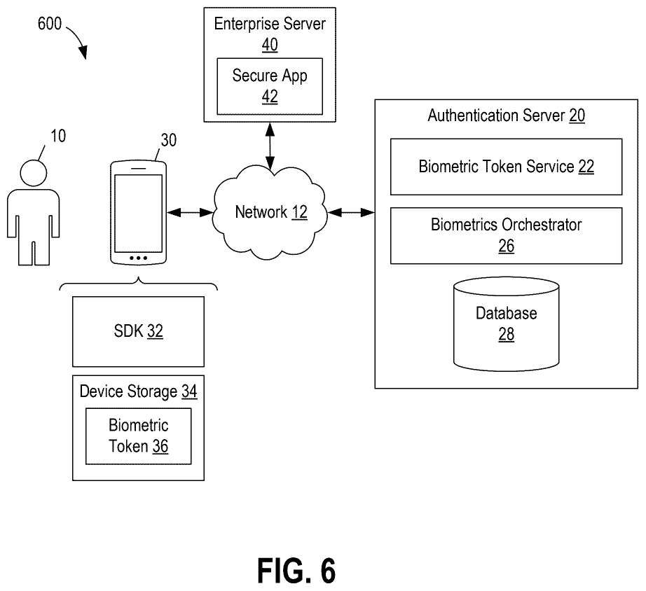

Turning now to FIG. 6, an example biometric token authentication system 600 is shown. Like the embodiment of the biometric token issuance system 100 described above in connection with FIG. 1, the illustrated embodiment of the biometric token authentication system 600 includes a computing device 30 connected to an authentication server 20 over a network 12. Additionally, the computing device 30 may be connected to an enterprise server 40 hosting a secure application 42.

In embodiments, a user 10 may use the computing device 30 to connect to the secure application 42 on the enterprise server 40. In an example, the enterprise server 40 requires the user 10 to be authenticated before allowing the computing device 30 to access the secure application 42. As described herein, the authentication server 20 may use the biometric token 36 to authenticate the user 10. In an example, the biometric token 36 may be the sole method of authenticating the user 10. For example, the biometric token 36 may be used during initial or step-up authentication. In another example, the biometric token 36 may be used in multi-factor authentication—e.g., in combination with a username/password.

As described above, the authentication server 20 may issue the biometric token 36 during an onboarding process, and the biometric token 36 may be stored in a device storage 34 on the computing device 30. In alternative examples, the biometric token 36 may be stored on other devices, such as the enterprise server 40. In embodiments, the biometric token 36 includes an embedding of an image of the user 10 captured during the onboarding process, which can be compared to an image of the user 10 captured during the authentication process to authenticate the user 10. In an embodiment, the embedding of the image of the user 10 includes a numerical representation of biometric data of the user 10 extracted from the image. For example, the embedding of the image of the user 10 may include a feature vector that represents biological characteristics of the user 10.

When the user 10 attempts the access the secure application 42, the SDK 32 may transmit the biometric token 36 to the authentication server 20. The SDK 32 may additionally transmit an image of the user 10 captured by the computing device 30 to the authentication server 20. A biometric token service 22 operating on the authentication server 20 may use the information stored on the biometric token 36 to authenticate the user 10. In embodiments, the biometric token 36 is encrypted during the onboarding process, as described above, and the biometric token service 22 decrypts the biometric token 36 during the authentication process.

In an example, the biometric token service 22 may check a database 28 to verify that the biometric token 36 is valid. As described above, the database 28 may maintain a list of token identifiers along with corresponding user identifiers (or hashes thereof) and statuses of the biometric tokens. The biometric token service 22 may read a token identifier from the biometric token 36 and use the token identifier to determine the status of the biometric token 36 listed in the database 28.

Similarly, the biometric token service 22 may verify that the biometric token 36 belongs to the user 10 being authenticated. In embodiments, the biometric token 36 includes a user identifier (e.g., a username) that belongs to the user 10 from the onboarding process. The biometric token service 22 may compare the user identifier stored on the biometric token 36 to a user identifier of the user 10 requesting authentication and a user identifier associated with the biometric token in the database 28. Similarly, hashes of the user identifiers may be compared. If the user identifiers match, the biometric token service 22 may determine that the biometric token 36 belongs to the user 10.

If the biometric token 36 is valid and belongs to the user 10, the biometric token service 22 may use a biometrics orchestrator 26 to determine if the user 10 is the same user 10 from onboarding. In an example, an embedding of an image of the user 10 captured during onboarding that is stored on the biometric token 36 is compared to an embedding of an image of the user 10 that is captured during the authentication process. If the embeddings match, authentication server 20 authenticates the user 10. In an example, a Euclidean distance between the embeddings is calculated, and if the Euclidean distance is less than a predetermined distance, the embeddings are determined to match.

After authenticating the user 10, the authentication server 20 can notify the enterprise server 40 that the user 10 is authenticated. The enterprise server 40 may then allow the user 10 to access the secure application 42 via the computing device 30.

Because the user 10 is authenticated using reference biometric data (e.g., the embedding of the image of the user 10) stored on the biometric token 36, the authentication server 20 can authenticate the user 10 without needing to maintain storage of personally identifiable information, such as reference biometric data, captured during onboarding to be stored in the database 28. Additionally, any personally identifiable information captured during the authentication process can be deleted during or after the authentication process. For example, the image of the user 10 can be deleted at any time after the embedding is generated. Like with the onboarding process, retention of personally identifiable information may be configurable. For example, the authentication server 20 may be configured to store personally identifiable information for less than two days.

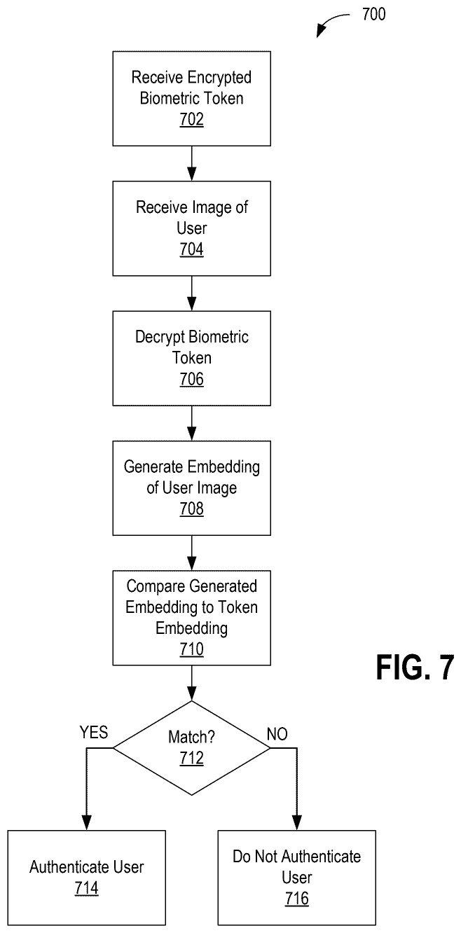

FIG. 7 illustrates a flowchart of an example method 700 for authenticating a user with a biometric token. In the illustrated embodiment, the method 700 includes operations 702, 704, 706, 708, 710, 712, 714, 716. In an example, the method 700 may be performed by an authentication server.

The operation 702 includes receiving an encrypted biometric token. In an example, the encrypted biometric token is received from a computing device of a user attempting to access a secure application. In another example, the encrypted biometric token may be received from an enterprise server. In an embodiment, an authentication server receives the encrypted biometric token over a network using a network interface.

The operation 704 includes receiving an image of a user. In an example, the image of the user includes an image of the user's face. In embodiments, the image of the user may be received from a computing device. In examples, the computing device from which the image of the user is received is the same computing device from which the encrypted biometric token is received. In an embodiment, an authentication server receives the image of the user over a network using a network interface.

In some embodiments, multiple images of the user are received. Similarly, in some embodiments, a video of the user may be received, and a frame of the video may be used as the image of the user. In examples, additional or alternative information is received along with the image of the user. For example, depth information may be received along with the image of the user. In embodiments, liveness detection is performed during authentication of the user to verify that the user is a real person and not a spoof, such as a printed image of the user presented to the camera.

The operation 706 includes decrypting the encrypted biometric token. As described herein, the biometric token may be encrypted using an AES-256-GCM symmetric cryptography algorithm. In an embodiment, an authentication server decrypts the biometric token using a decryption key maintained at the authentication server. In another example, a key management system may maintain the decryption key used to decrypt the biometric token. By decrypting the biometric token, the information stored thereon can be accessed, including an embedding of an image of the user captured during onboarding.

The operation 708 includes generating an embedding of the image of the user received during the operation 704. In an embodiment, the embedding of the image of the user includes a numerical representation of biometric data of the user extracted from the image. For example, the embedding of the image of the user may include a feature vector that represents biological characteristics of the user. In an example embodiment, a biometrics orchestrator of an authentication server generates the embedding of the image of the user.

The operation 710 includes comparing the embedding of the image of the user to a reference embedding stored on the biometric token. In an example, a Euclidean distance between the embeddings is calculated. In an embodiment, a biometrics orchestrator of an authentication server compares the embedding of the image of the user to the reference embedding.

The operation 712 includes determining if the embedding of the image of the user and the reference embedding stored on the biometric token match. In an example, if the Euclidean distance calculated during the operation 710 is less than a predetermined threshold, the embeddings are determined to match. In an embodiment, a biometrics orchestrator of an authentication server determines if the embedding of the image of the user matches the reference embedding. The threshold used for matching of embeddings may be adjustable at the authentication server based on historical records, audit of authentication results, and the like. In some examples, an enterprise may set a sensitivity or accuracy level that corresponds to the threshold used for matching of the embeddings, corresponding to a preferred sensitivity that may correspond to sensitivity of data being protected by the authentication server (e.g., at the secure application 42).

If the embeddings match, the method 700 proceeds to the operation 714 and the user is authenticated. In an example, an authentication server notifies a computing device that the user has been authenticated. For example, the authentication server may notify the enterprise server of the result of an attempted authentication. Based on that result, the authenticated user may then be granted access a secure application—e.g., by the enterprise server. In some other example implementations, the authentication server may notify other computing devices, such as an SDK executable on the computing device of the user (e.g., computing device 30) of the result of authentication, which may then enable access the secure application at the enterprise server based on the returned authentication.

If the embeddings do not match, the method 700 proceeds to the operation 716 and the user is not authenticated. In an example, the unauthenticated user may be denied access to the secure application—e.g., by the enterprise server. For example, the authentication server may notify either the enterprise server or an SDK on a computing device of the user that the attempted authentication was unsuccessful, and the SDK or the enterprise server may in turn deny access to the secure application at the computing device of the user. Alternatively, the authentication server may not return a result to the SDK or enterprise server in the event of unsuccessful attempted authentication, resulting in a determination that the attempt has failed (e.g., due to timeout).

As described with the method 700 generally, users can be authenticated without requiring reference biometric data or other personally identifiable information to be maintained on an authentication server for extended periods of time. In example method 700 described above, the user is authenticated based on the biometric token that is managed by the user (e.g., stored on a computing device of the user) rather than the biometric token—or the data stored thereon—being managed by the authentication server.

While the example method 700 describes authenticating a user using an image of the user and a biometric token maintaining an embedding of a reference image of the user, in alternative embodiments, other biometrics may be used to authenticate the user. For example, a fingerprint of the user may be scanned and compared against a reference fingerprint scan stored on the biometric token.

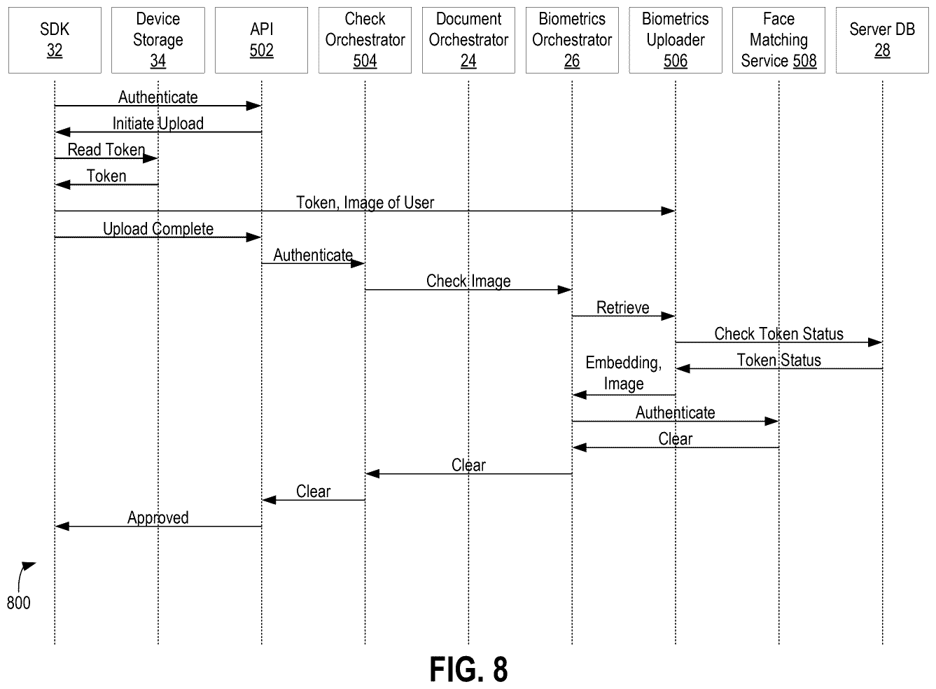

FIG. 8 illustrates an example message flow diagram 800 for authenticating a user with a biometric token. Like the message flow diagram 500 described above in connection with FIG. 5, the illustrated message flow diagram 800 shows communications between an SDK 32, a device storage 34, an API 502, a check orchestrator 504, a document orchestrator 24, a biometrics orchestrator 26, a biometrics uploader 506, a face matching service 508, and an authentication server database 28. In an embodiment, the SDK 32 and the device storage 34 are part of a user's computing device. The API 502, the check orchestrator 504, the document orchestrator 24, the biometrics orchestrator 26, the biometrics uploader 506, the face matching service 508, and the authentication server database 28 may be part of an authentication server.

In some example implementations, the message flow diagram 800 for authenticating a user may be utilized after a biometric token is issued, for example using the message flow diagram 500 of FIG. 5. As such, the message flow diagram 800 may be performed as authentication of a user who has enrolled in biometric authentication previously, and is maintaining a biometric token in device storage of a device associated with that user. In some particular examples, authenticating a user using a biometric token as described herein may be used as a primary mechanism of authentication. In alternative examples, the biometric token-based authentication processes described herein may be used as either a multifactor authentication (MFA) method in addition to another type of authentication (e.g., username/password, access card-based authentication, certificate-based authentication, directory-based authentication, or other biometric methods, for example.

In some specific examples, the biometric token-based authentication described herein may be used for step-up authentication, which refers to a particular instance in which a higher-security authentication methodology is required when triggered by, e.g., irregular user behavior, an access request from an unfamiliar device, or various types of high-risk transactions (e.g., a transaction having a high monetary value, or which may provide access to a highly-sensitive data resource). In such instances, the biometric token-based authentication may be used as the additional, or replacement (higher security) authentication method used.

Referring to the message flow diagram 800 specifically, the SDK 32 may transmit a request to the API 502 to authenticate a user. In an example, the SDK 32 may transmit the request in response to the user attempting to access a secure application. The API 502 may respond by instructing the SDK 32 to initiate upload of the encrypted biometric and an image of the user. The SDK 32 may capture an image of the user and retrieve the encrypted biometric token from the device storage 34. The SDK 32 may upload the encrypted biometric token and the image of the user to the biometrics uploader 506. After uploading the encrypted biometric token and the image of the user, the SDK 32 may inform the API 502 that the upload is complete.

As above, after the API 502 is notified that the biometric token has been stored, in some examples, any biometric data stored at the biometrics uploader 506 or other components of an authentication server may be caused to delete biometric data, while retaining the token record. This enables a subsequently-received version of the biometric token to be associated with a particular token record, ensuring that a biometric authentication process is performed for only users registered with the authentication server.

The API may use the check orchestrator 504 to authenticate the user. In the illustrated embodiment, the check orchestrator 504 uses the biometrics orchestrator 26 to authenticate the user. Because the user may be authenticated by comparing the image of the user to biometric data embedded on the biometric token, the check orchestrator 504 may not use the document orchestrator 24 during the authentication process as an identity document may not be authenticated during the authentication process.

The biometrics orchestrator 26 may request the embedding stored on the biometric token and the image of the user from the biometrics uploader 506. The biometrics uploader 506 may decrypt the biometric token and verify that the biometric token is valid. To verify that the biometric token is valid, the biometrics uploader 506 may check the status of the biometric token in the authentication server database 28 using a token identifier stored on the biometric token. The biometrics uploader 506 may also verify that the biometric token belongs to the user. In an example, the biometrics uploader 506 may check the user identifier associated with the biometric token in the database 28 and verify it matches the user identifier of the user requesting authentication and the user identifier stored on the biometric token.

If the biometric token is valid and belongs to the user, the biometrics uploader 506 transmits the embedding from the biometric token and the image of the user to the biometrics orchestrator 26. If the biometric token is invalid or does not belong to the user, the biometrics uploader 506 or the biometrics orchestrator 26 may inform the API 502 that the biometric token is invalid and the user is not authenticated.

The biometrics orchestrator 26 may use a face matching service 508 to determine if the image of the user captured during the authentication process matches the image of the user captured during the onboarding process. The face matching service 508 may generate an embedding of the image of the user captured during the authentication process and compare the embedding to reference embedding retrieved from the biometric token. In an example, the face matching service calculates a Euclidean distance between the embeddings, and if the distance is less than a predetermined threshold, the embeddings are determined to match.

The results of the authentication may be transmitted back to the SDK 32 through the biometrics orchestrator 26, the check orchestrator 504, and the API 502. If the user is authenticated, the user may then access the secure application. Upon completion (e.g., after a predetermined period of time, or after receipt of confirmation of authentication at the API 502 from the SDK 32), biometric data may be deleted from components of the authentication server, such as the server database 28, and other components of FIG. 8—other than SDK 32 and device storage 34 operating on a user's computing device.

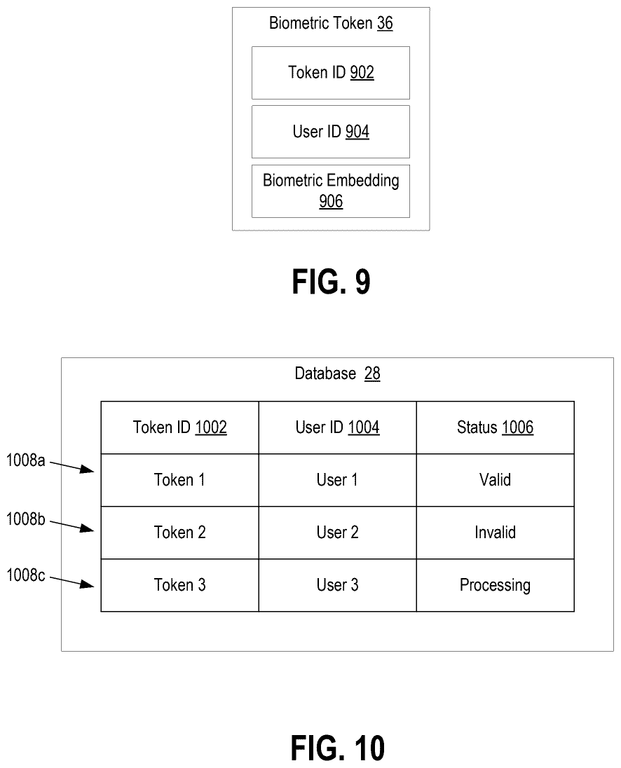

Turning to FIG. 9, an example of a biometric token 36 is provided. As described above, the biometric token 36 may be issued by an authentication server to be used for authenticating a user. In the illustrated embodiment, the biometric token 36 includes a token identifier 902, a user identifier 904, and a biometric embedding 906. In examples, the biometric token 36 is a JSON payload.

The token identifier 902 may be a unique identifier for the biometric token 36. In an example, the token identifier 902 may be used to verify that the biometric token 36 is valid during an authentication process. As described above, in an embodiment, the identity of a user requesting a biometric token 36 is verified during an onboarding process. If the user is successfully verified during the onboarding process, the issued biometric token 36 may be valid, and a token record stored on an authentication server may indicate that the biometric token is valid. The status of the biometric token 36 may similarly be recorded in the token record at the authentication server. The token identifier 902 may be used to identify the corresponding token record and determine if the biometric token 36 is valid. In an embodiment, the token identifier 902 may include a signature generated by the authentication server. This may, for example, allow the authentication server to verify that the biometric token 36 was created by the authentication server.

The user identifier 904 may identify a user associated with the biometric token 36. In an example, the user identifier 904 is used during an authentication process to verify that the biometric token 36 belongs to the user being authenticated. As described above, during an authentication process, the user identifier 904 stored in the biometric token 36 may be compared to an identifier of the user requesting authentication and a user identifier stored in an authentication server database. If the identifiers match, the biometric token 36 may be determined to belong to the user requesting authentication.

The biometric embedding 906 includes an embedding of reference biometric data of an associated user. In an example, the biometric embedding 906 may include an embedding of an image of a user captured during an onboarding process. For example, the embedding of the image of the user may include a feature vector that represents biological characteristics of the user. As described above, the biometric embedding 906 may be used to authenticate the user during an authentication process. For example, the biometric embedding 906 may be compared to an embedding of biometric data captured during the authentication process. If the embeddings match, the user may be authenticated.

In alternative embodiments, the biometric token 36 may include additional or alternative information. For example, additional metadata about the user or the onboarding process may be stored on the biometric token 36.

FIG. 10 illustrates example token records 1008 maintained in a database 28 of an authentication server. In the illustrated example, each token record 1008 includes a token identifier 1002, a user identifier 1004, and a status 1006 associated with a biometric token. As described above, during authentication of a user, the token record 1008 may be checked to verify that a biometric token is valid.

In embodiments, the user identifier 1004 is checked to verify that the biometric token being used during the authentication process belongs to the user being authenticated, as described above. In some embodiments, the user identifier 1004 stored in the database 28 is a hash of a user identifier, such as the user identifier 904 stored on a biometric token 36 as described in connection with FIG. 9.

In the illustrated example, the token records 1008 are associated with three different statuses 1006. A first token record 1008a is associated with a “valid” status. As described above, a biometric token may be assigned a “valid” status if the user is authenticated during an onboarding process. A second token record 1008b is associated with an “invalid” status. A biometric token may be assigned an “invalid” status if the user fails authentication during the onboarding process. A third token record 1008c is associated with a “processing” status. A biometric token may be assigned a “processing” status during the onboarding process if the biometric token has been created but the user has not yet been authenticated.

In alternative embodiments, the token records 1008 may include additional or alternative information. For example, additional metadata associated with the biometric token, the onboarding process, or authentication processes may be stored in the token record 1008.

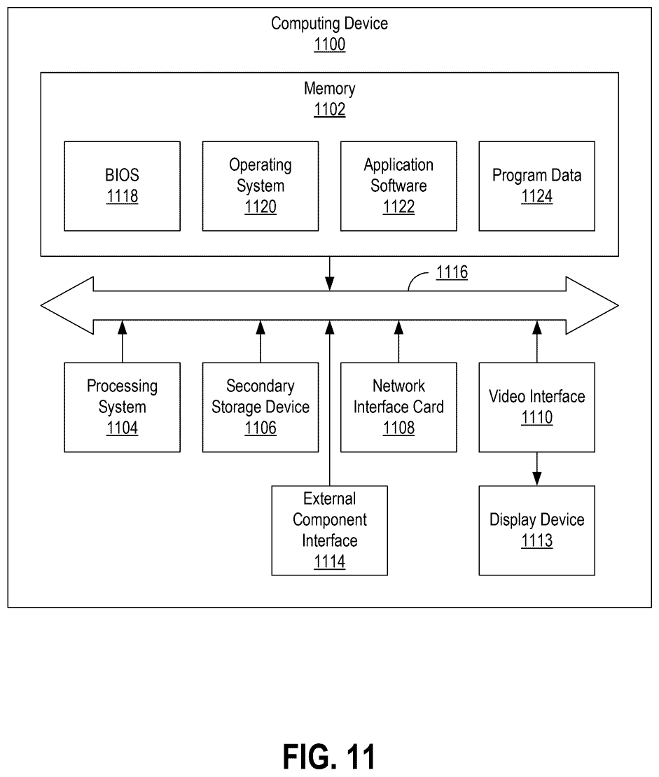

FIG. 11 illustrates an example computing device 1100 on which aspects of the present disclosure may be implemented. The computing device 1100 can be used, for example, to implement computing devices such as the computing device 30, the authentication server 20, or any other computing device useable as described above in connection with FIGS. 1, 2, and 6.

In the example of FIG. 11, the computing device 1100 includes a memory 1102, a processing system 1104, a secondary storage device 1106, a network interface card 1108, a video interface 1110, a display unit 1113, an external component interface 1114, and a communication medium 1116. The memory 1102 includes one or more computer storage media capable of storing data and/or instructions. In different embodiments, the memory 1102 is implemented in different ways. For example, the memory 1102 can be implemented using various types of computer storage media, and generally includes at least some tangible media. In some embodiments, the memory 1102 is implemented using entirely non-transitory media.

The processing system 1104 includes one or more processing units, or programmable circuits. A processing unit is a physical device or article of manufacture comprising one or more integrated circuits that selectively execute software instructions. In various embodiments, the processing system 1104 is implemented in various ways. For example, the processing system 1104 can be implemented as one or more physical or logical processing cores. In another example, the processing system 1104 can include one or more separate microprocessors. In yet another example embodiment, the processing system 1104 can include an application-specific integrated circuit (ASIC) that provides specific functionality. In yet another example, the processing system 1104 provides specific functionality by using an ASIC and by executing computer-executable instructions.

The secondary storage device 1106 includes one or more computer storage media. The secondary storage device 1106 stores data and software instructions not directly accessible by the processing system 1104. In other words, the processing system 1104 performs an I/O operation to retrieve data and/or software instructions from the secondary storage device 1106. In various embodiments, the secondary storage device 1106 includes various types of computer storage media. For example, the secondary storage device 1106 can include one or more magnetic disks, magnetic tape drives, optical discs, solid-state memory devices, and/or other types of tangible computer storage media.

The network interface card 1108 enables the computing device 1100 to send data to and receive data from a communication network. In different embodiments, the network interface card 1108 is implemented in different ways. For example, the network interface card 1108 can be implemented as an Ethernet interface, a fiber optic network interface, a wireless network interface (e.g., WiFi, WiMax, Bluetooth, etc.), or another type of network interface.

In optional embodiments where included in the computing device 1100, the video interface 1110 enables the computing device 1100 to output video information to the display unit 1113. The display unit 1113 can be various types of devices for displaying video information, such as an LCD display panel, a plasma screen display panel, a touch-sensitive display panel, an LED or OLED screen, a cathode-ray tube display, or a projector. The video interface 1110 can communicate with the display unit 1113 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 1114 enables the computing device 1100 to communicate with external devices. For example, the external component interface 1114 can be a USB interface and/or another type of interface that enables the computing device 1100 to communicate with external devices or peripheral devices integrated within the same housing (e.g., in the case of mobile devices). In various embodiments, the external component interface 1114 enables the computing device 1100 to communicate with various external components, such as external storage devices, input devices, speakers, modems, media player docks, other computing devices, scanners, digital cameras, and fingerprint readers.

The communication medium 1116 facilitates communication among the hardware components of the computing device 1100. The communication medium 1116 facilitates communication among the memory 1102, the processing system 1104, the secondary storage device 1106, the network interface card 1108, the video interface 1110, and the external component interface 1114. The communication medium 1116 can be implemented in various ways. For example, the communication medium 1116 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 1102 stores various types of data and/or software instructions. The memory 1102 stores a Basic Input/Output System (BIOS) 1118 and an operating system 1120. The BIOS 1118 includes a set of computer-executable instructions that, when executed by the processing system 1104, cause the computing device 1100 to boot up. The operating system 1120 includes a set of computer-executable instructions that, when executed by the processing system 1104, cause the computing device 1100 to provide an operating system that coordinates the activities and sharing of resources of the computing device 1100. Furthermore, the memory 1102 stores application software 1122. The application software 1122 includes computer-executable instructions, that when executed by the processing system 1104, cause the computing device 1100 to provide one or more applications. In an example, the memory 1102 stores application software 1122 for an SDK. The memory 1102 also stores program data 1124. The program data 1124 is data used by programs that execute on the computing device 1100.

Although particular features are discussed herein as included within an electronic computing device 1100, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include various types of dynamic random access memory (DRAM), solid state memory, read-only memory (ROM), electrically-erasable programmable ROM, magnetic disks (e.g., hard disks, floppy disks, etc.), and other types of devices and/or articles of manufacture that store data. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

It is noted that, in some embodiments of the computing device 1100 of FIG. 11, the computer-readable instructions are stored on devices that include non-transitory media. In particular embodiments, the computer-readable instructions are stored on entirely non-transitory media.

Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

1. A system for authenticating a user, the system comprising:
an authentication server comprising:
one or more processors; and
one or more computer-readable storage devices storing data instructions that, when executed by the one or more processors, cause the authentication server to:
execute an onboarding process, wherein to execute the onboarding process includes to:
receive a first image of a user;
receive an image of an identity document, wherein the identity document includes a second image of the user; and
generate a biometric token, the biometric token including an embedding representing biometric data obtained from the first image of the user; and
execute an authentication process, wherein to execute the authentication process includes to:
receive a third image of the user;
generate an embedding representing biometric data obtained from the third image of the user;
compare the embedding obtained from the third image of the user to the embedding obtained from the first image of the user from the biometric token; and
based on the comparison, authenticate the user.

2. The system of claim 1, wherein to execute the onboarding process further includes to:
transmit the biometric token to a computing device; and
delete the first image of the user and the image of the identity document from the authentication server after generating the biometric token; and
wherein to execute the authentication process further includes to:
receive the biometric token.

3. The system of claim 2, wherein deletion of the first image of the user and the image of the identity document is before execution of the authentication process.

4. The system of claim 1, wherein to execute the authentication process further includes to:
determine, based on a token identifier included on the biometric token, a status of the biometric token, wherein authentication of the user is further based on the status of the biometric token; and
determine, based on a user identifier included on the biometric token, whether the biometric token belongs to the user, wherein authentication of the user is further based on the biometric token belonging to the user.

5. The system of claim 1, wherein to execute the onboarding process further includes to:
verify an identity of the user based on the first image of the user and the image of the identity document; and
update a status of the biometric token based on verifying the identity of the user.

6. The system of claim 5, wherein to execute the onboarding process further includes to:
perform liveness detection based on the first image of the user, wherein verification of the identity of the user is further based on the liveness detection; and
wherein to execute the authentication process further includes to:
perform liveness detection based on the third image of the user, wherein authentication of the user is further based on the liveness detection.

7. The system of claim 5, wherein to verify the identity of the user based on the first image of the user and the image of the identity document includes to:
compare the embedding of the first image of the user to an embedding of the second image of the user.

8. The system of claim 1, wherein the computing device is a mobile device of the user.

9. The system of claim 1, wherein the computing device is an enterprise server.

10. The system of claim 1, further comprising:
the computing device comprising:
one or more processors; and
one or more computer-readable storage devices storing data instructions that, when executed by the one or more processors, cause the computing device to:
capture the first image of the user;
capture the image of the identity document;
transmit the first image of the user and the image of the identity document to the authentication server;
receive, from the authentication server, the biometric token;
store, at the computing device, the biometric token;
capture the third image of the user; and
transmit the third image of the user and the biometric token to the authentication server.

11. The system of claim 1, wherein to execute the onboarding process further includes to:
encrypt biometric token; and
wherein to execute the authentication process includes to:
decrypt the biometric token.

12. The system of claim 1, wherein the authentication process is a step-up authentication process.

13. A system for authenticating a user, the system comprising:
a computing device comprising:
one or more processors; and
one or more computer-readable storage devices storing data instructions that, when executed by the one or more processors, cause the computing device to:
capture a first image of a user;
capture an image of an identity document, the identity document including a second image of the user;
transmit the first image of the user and the image of the identity document to an authentication server, wherein the authentication server verifies an identity of the user based on the first image of the user and the image of the identity document;
receive, from the authentication server, a biometric token, the biometric token including an embedding representing biometric data obtained from the first image of the user;
store the biometric token;
capture a third image of the user; and
transmit the third image of the user and the biometric token to the authentication server, wherein the authentication server authenticates the user based on a comparison between an embedding representing biometric data obtained from the third image of the user and the embedding of the first image of the user from the biometric token.

14. The system of claim 13, further comprising:
the authentication server comprising:
one or more processors; and
one or more computer-readable storage devices storing data instructions that, when executed by the one or more processors, cause the authentication server to:
execute an onboarding process, wherein to execute the onboarding process includes to:
receive the first image of a user;
receive the image of the identity document;
generate the biometric token;
transmit the biometric token to the computing device; and
verify the identity of the user based on the first image of the user and the image of the identity document; and
execute an authentication process, wherein to execute the authentication process includes to:
receive the third image of the user;
receive the biometric token;
generate the embedding of the third image of the user;
compare the embedding of the third image of the user to the embedding of the first image of the user from the biometric token; and
based on the comparison, authenticate the user.

15. A method for authenticating a user, the method comprising:
executing an onboarding process at an authentication server, wherein executing the onboarding process includes:
receiving a first image of a user;
receiving an image of an identity document, wherein the identity document includes a second image of the user; and
generating a biometric token, the biometric token including an embedding representing biometric data obtained from the first image of the user; and
executing an authentication process at the authentication server, wherein executing the authentication process includes:
receiving a third image of the user;
generating an embedding representing biometric data obtained from the third image of the user;
comparing the embedding from the third image of the user to the embedding from the first image of the user from the biometric token; and
based on the comparison, authenticating the user.

16. The method of claim 15, further comprising:
capturing the first image of the user;
capturing the image of the identity document;
transmitting the first image of the user and the image of the identity document to the authentication server;
receiving, from the authentication server, the biometric token;
storing, at the computing device, the biometric token;
capturing the third image of the user; and
transmitting the third image of the user and the biometric token to the authentication server.

17. The method of claim 15, wherein executing the authentication process at the authentication server further includes:
determining, based on a token identifier, a status of the biometric token, wherein authentication of the user is further based on the status of the biometric token; and
determining, based on a user identifier, whether the biometric token belongs to the user, wherein authentication of the user is further based on the biometric token belonging to the user.

18. The method of claim 15, wherein executing the onboarding process at the authentication server further includes:
performing liveness detection on the first image;
verifying an identity of the user based on the first image of the user and the image of the identity document; and
updating a status of the biometric token based on the liveness detection and verifying the identity of the user; and
wherein executing the authentication process at the authentication server further includes:
performing liveness detection on the third image, wherein authentication of the user is further based on the liveness detection.

19. The method of claim 15, wherein verifying the identity of the user based on the first image of the user and the image of the identity document includes:
comparing the embedding of the first image of the user to an embedding of the second image of the user.

20. The method of claim 15, wherein executing the onboarding process at the authentication server further includes:
transmitting the biometric token to a computing device; and
deleting the first image of the user and the image of the identity document from the authentication server.

21. The method of claim 20, wherein the deletion of the first image of the user and the image of the identity document is before execution of the authentication process.

22. A method for authenticating a user, the method comprising:
receiving a first image of a user;
generating an embedding representing biometric data obtained from the first image of the user;
comparing the embedding from the first image of the user to an embedding representing biometric data obtained from a second image of the user, wherein the embedding from the second image of the user is stored on a biometric token; and
based on the comparison, authenticating the user.

23. The method of claim 22, further comprising:
receiving the second image of a user;
receiving an image of an identity document, wherein the identity document includes a third image of the user; and
generating the biometric token.

24. The method of claim 23, further comprising:
transmitting the biometric token to a computing device;
deleting the first image of the user and the image of the identity document from the authentication server; and
receiving the biometric token from the computing device.

25. The method of claim 23, further comprising:
verifying an identity of the user based on the second image of the user and the image of the identity document.

26. A system for authenticating a user, the system comprising:
one or more processors; and
one or more computer-readable storage devices storing data instructions that, when executed by the one or more processors, cause the system to:
capture a first image of a user;
transmit the first image of the user to an authentication server; and
transmit a biometric token to the authentication server, the biometric token including an embedding representing biometric data obtained from a second image of the user, wherein the biometric token is stored in the one or more computer-readable storage devices,
wherein the authentication server authenticates the user based on a comparison between an embedding representing biometric data obtained from the first image of the user and the embedding from the second image of the user from the biometric token.

27. The system of claim 26, wherein the instructions, when executed by the one or more processors, further cause the system to:
capture a third image of the user;
capture an image of an identity document, the identity document including the second image of the user;
transmit the third image of the user and the image of the identity document to the authentication server, wherein the authentication server verifies an identity of the user based on the third image of the user and the image of the identity document;
receive, from the authentication server, the biometric token; and
store the biometric token in the one or more computer-readable storage devices.
